(19) United States
(12) Patent Application Publication
(10) Pub. No.: US 2012/0305279 A1
(43) Pub. Date: Dec. 6, 2012

(54) Hand Power Tool Device

(75) Inventors: Joachim Schadow, Stuttgart (DE); Sinisa Andrasic, Schoenaich (DE); Marcus Schuller, Dettenhausen (DE)

(73) Assignee: Robert Bosch GmbH, Stuttgart (DE)

(21) Appl. No.: 13/520,563

(22) PCT Filed: Nov. 23, 2010
(86) PCT No.: PCT/EP10/68003

§ 371 Date: Jul. 4, 2012

(30) Foreign Application Priority Data
Jan. 7, 2010 (DE) 102010000722.6

(51) Int. Cl. B25F 5/00

(52) U.S. Cl. 173/171

(57) ABSTRACT

A hand power tool device includes at least one drive shaft, a drive motor, an insert tool fixing means, and at least one bearing unit which is provided for bearing the drive shaft on a side of the drive motor, said side facing away from the insert tool fixing means. The hand power tool device also includes a sealing device which is provided for sealing at least one region which lies axially adjacent to the bearing unit and which lies on a side of the bearing unit, said side facing away from the insert tool fixing mean. The sealing device has at least one sealing element which is designed separately from the bearing unit.

### PRIOR ART

The invention proceeds from a portable power tool device as per the preamble of claim 1.

A portable power tool device having at least a driveshaft, a drive motor, an application tool fastening and at least a bearing unit which is provided to support the driveshaft on a side of the drive motor that is remote from the application tool fastening, having a sealing device which is provided to seal off at least a region which is located axially next to the bearing unit and is arranged on a side of the bearing unit that is remote from the application tool fastening, has already been proposed.

### SUMMARY OF THE INVENTION

The invention proceeds from a portable power tool device having at least a driveshaft, a drive motor, an application tool fastening and at least a bearing unit which is provided to support the driveshaft on a side of the drive motor that is remote from the application tool fastening, having a sealing device which is provided to seal off at least a region which is located axially next to the bearing unit and is arranged on a side of the bearing unit that is remote from the application tool fastening.

It is proposed that the sealing device has at least one sealing element which is formed separately from the bearing unit. A “driveshaft” should be understood as meaning in particular a shaft which, during operation, transmits energy applied by the drive motor directly or indirectly to the application tool fastening and is connected preferably directly to a rotor of the drive motor. In particular, a “drive motor” should be understood as meaning a motor which, during operation, provides a movement which directly or indirectly moves the application tool fastening. An “application tool fastening” should be understood as meaning in particular a device which is provided to fasten an application tool directly, in particular in a detachable manner without using a tool. In particular, a “bearing unit” should be understood as meaning a ball bearing, a plain bearing, a roller bearing and/or some other bearing that appears to be practical to a person skilled in the art. “Provided” should be understood as meaning in particular specially equipped and/or designed. The term “sealing device” should be understood as meaning in particular a device which prevents dust, dirt and/or moisture from penetrating into a sealed-off region. A “sealing element” should be understood as meaning in particular an element which, on account of a spatial arrangement and/or a spatial expansion, achieves a sealing effect preferably in a space between objects that are moved in relation to one another, and in particular an element which seals off between the driveshaft and a further component, such as in particular between the driveshaft and a housing element and/or a motor element. In particular, the sealing device seals off the region according to DIN EN 60529 (VDE 0470-1) at least corresponding to protection class IP 5X, advantageously at least IP 54, particularly advantageously at least IP 67. Advantageously, the sealing device is formed as a contact seal. Alternatively, the sealing device could be formed as a noncontact seal. Preferably, the sealing device is formed as a shaft seal and provides sealing in particular axially along the drive shaft. The expression “formed separately” should be understood as meaning in particular that the bearing unit and the sealing element form separate subassemblies in an assembled state separated from the axis of rotation. Advantageously, the bearing unit and the sealing element are each located on one of two different planes which are oriented perpendicularly to an axis of rotation of the driveshaft. Preferably, the bearing unit and the sealing element are arranged at a spacing of at least 0.2 mm, advantageously of at least 1 mm, from one another at every point in the axial direction of the driveshaft. On account of the embodiment according to the invention of the portable power tool device, a space which is sealed off particularly effectively from fine dust and moisture can be provided for sensitive electronic units, such as for a rotational speed sensor, a vibration sensor, an inclination sensor, an acceleration sensor and/or a temperature sensor, for example, and/or for other electronic units.

In a further embodiment, it is proposed that the sealing device has at least two sealing elements. Advantageously, the sealing element has an elastically deformable material, such as in particular a plastics material, a felt with or without impregnation, an elastomer, a gaseous element, a liquid element and/or some other element that appears to be practical to a person skilled in the art. Alternatively, the sealing element and/or the other region of the sealing device could consist at least partially of metal. On account of the two sealing elements, a particularly reliable sealing effect can be achieved, in particular when the sealing elements have two different sealing effects, for example for operation and for storage.

Furthermore, it is proposed that the two sealing elements are arranged on different sides of the bearing unit. The expression “on different sides of the bearing unit” should be understood as meaning in particular that the sealing elements are arranged in the axial direction in front of and behind the bearing unit and are arranged in particular coaxially with the bearing unit, as a result of which particularly effective sealing can be achieved.

It is further proposed that the bearing unit has at least one sealing element, that is to say that the bearing unit and the sealing element form a self-contained unit in an assembled state separated from the axis of rotation. Preferably, the sealing element of the bearing unit is arranged at least partially within an external bearing ring in an axial region spanned by the bearing unit. On account of the sealing element of the bearing unit, an additional advantageous sealing effect can be achieved. Alternatively, the bearing unit could also be formed in an unsealed manner and as a result be particularly inexpensive.

In addition, it is proposed that the sealing device has a sealing lip. A “sealing lip” should be understood as meaning in particular an element which, in at least one operating state, is pressed, preferably at one end, against a sealing surface and/or a sealing edge by a force which is oriented preferably antiparallel to a main extent of the sealing lip, and in the process is in particular elastically deflected. Preferably, the sealing lip has, in an axial section, in particular on one symmetrical side, an extent ratio between the main extent and an extent transversely to the main extent of at least 2:1, advantageously at least 4:1. On account of the sealing lip, a particularly efficient and in particular low-friction seal can be achieved in a structurally simple manner.

In an advantageous embodiment of the invention, it is proposed that the sealing lip is prestressed in at least one operating state, as a result of which a particularly reliable seal can be achieved. “Prestressed” should be understood as meaning in particular that the sealing lip, in an assembled operating state, presses by way of a force against the sealing surface and/or the sealing edge, and so the sealing lip is deformed, compared with an unloaded state, by at least 200 μm, preferably by at least 500 μm, by an opposing force at at least one point.

In a further embodiment, it is proposed that the sealing device has a sealing ring. A “sealing ring” should be understood as meaning in particular an element which is provided to be deformed without pivoting, and in particular is configured in the form of an O-ring. On account of the sealing ring, a particularly high sealing effect can be achieved in a structurally simple manner.

Furthermore, it is proposed that the sealing device comprises at least one labyrinth seal, as a result of which a particularly low-wear, durable and inexpensive seal can be achieved in a structurally simple manner. A “labyrinth seal” should be understood as meaning in particular a seal which achieves a sealing effect by way of a geometrically long path between two sealing surfaces and/or sealing edges and in particular parallel to the sealing surfaces, in particular on account of a high flow resistance between the sealing surfaces. The path is in particular longer than 3 mm, advantageously longer than 10 mm, particularly advantageously longer than 30 mm. Advantageously, the labyrinth seal provides sealing in a noncontact manner in at least one operating state, that is to say that the two sealing surfaces and/or sealing edges, or generally the sealing surface and/or sealing edge and a sealing element, are spaced apart from one another at least a little at every point. Preferably, the sealing device has, in addition to the labyrinth seal, a further sealing means that appears to be practical to a person skilled in the art.

It is further proposed that the sealing device comprises at least one centrifugal seal. A “centrifugal seal” should be understood as meaning in particular a seal which is provided to be deformed by a centrifugal force. Preferably, one sealing element of the centrifugal seal is connected in a rotationally fixed manner to the driveshaft. Advantageously, the centrifugal seal provides noncontact sealing in at least one operating state. On account of the centrifugal seal, a particularly advantageous and efficient sealing effect can be achieved in different operating states, in particular during operation and storage. Preferably, the centrifugal seal has a further sealing means that appears to be practical to a person skilled in the art.

Moreover, it is proposed that the sealing device has at least one spring element, which is provided at least to exert a force on a sealing means, as a result of which a particularly advantageous sealing effect can be achieved. A “spring element” should be understood as meaning in particular an element which is in the form of a metallic spring element, an elastomeric spring element, a pressurized medium, a bellows spring, a spring element that appears to be practical to a person skilled in the art and/or advantageously a helical spring. Preferably, the spring element is formed by a component which is formed separately from the sealing means.

In an advantageous embodiment of the invention, it is proposed that the sealing device has an elastic sealing disk, as a result of which particularly reliable and robust sealing is possible. The term “elastic” should be understood as meaning in particular that the sealing disk is composed of a material which is provided to be deformed in operation and/or during mounting, such as felt, elastomer, brushes, for example, and/or some other means that appears to be practical to a person skilled in the art. Preferably, the elastic sealing disk is deformable by at least 0.5 mm, advantageously 1 mm, in order to compensate for play in the driveshaft.

In addition, it is proposed that the portable power tool has at least one electronic unit and at least one sensor, which are arranged in the sealed-off region, as a result of which available installation space can advantageously be used functionally and it is possible in particular to dispense with a further sealed-off installation space for electronic units. An “electronic unit” should be understood as meaning in particular a device in which an electric current is passed through a gas, a semiconductor and/or through a vacuum. Preferably, the electronic unit has a computing unit.

The invention further proceeds from a portable power tool having a portable power tool device, wherein all portable power tools which appear to be practical to a person skilled in the art, such as, in particular, demolition hammers, saws, planes, screwdrivers, milling machines, drilling machines, grinders, multifunction tools and/or in particular angle grinders, would be conceivable for operation with a portable power tool device, as a result of which the portable power tool and the portable power tool device can be matched particularly advantageously to one another.

### DRAWING

Further advantages can be gathered from the following description of the drawing. The drawing illustrates 21 exemplary embodiments of the invention. The drawing, the description and the claims contain numerous features in combination. A person skilled in the art will expediently also consider the features individually and combine them to form practical further combinations.

In the drawing:

FIG. 1 shows a portable power tool having a portable power tool device according to the invention which has a sealing device having a sealing lip,

FIG. 2 shows a partial section through the portable power tool device from FIG. 1,

FIGS. 3 to 10 each show a partial section through a further exemplary embodiment of a portable power tool device having differently arranged sealing lips,

FIGS. 11 to 16 each show a partial section through a further exemplary embodiment of a portable power tool device having differently arranged sealing rings,

FIGS. 17 to 19 each show a partial section through a further exemplary embodiment of a portable power tool device having different labyrinth seals,

FIGS. 20 and 21 each show a partial section through a further exemplary embodiment of a portable power tool device having different centrifugal seals, and

FIG. 22 shows a partial section through the portable power tool device having an elastic sealing disk.

### DESCRIPTION OF THE EXEMPLARY EMBODIMENTS

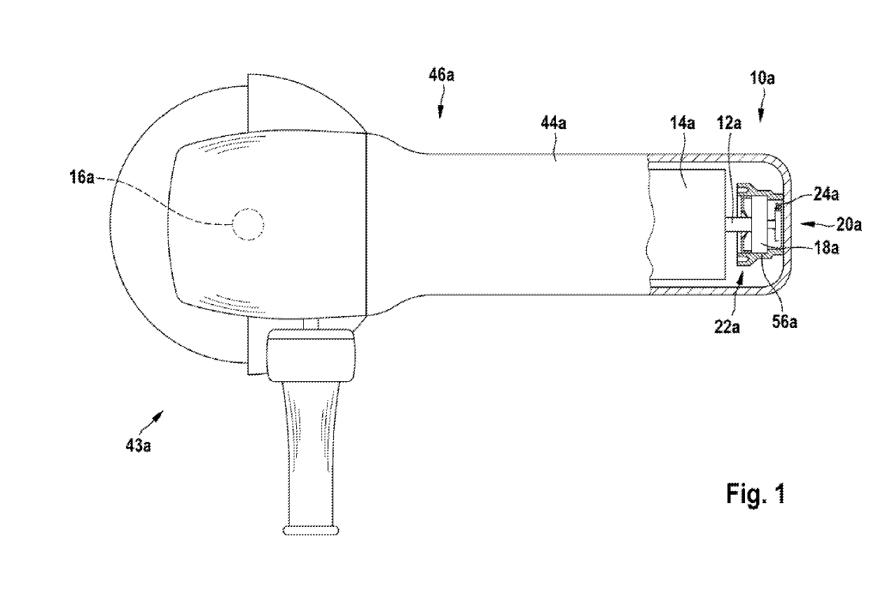

FIG. 1 shows a portable power tool 43a with a partial section in which a portable power tool device 10a according to the invention of the portable power tool 43a is shown. The portable power tool 43a is in the form of an angle grinder. The portable power tool device 10a comprises a driveshaft 12a, a drive motor 14a, an application tool fastening 16a and a bearing unit 18a. The driveshaft 12a operatively connects the drive motor 14a to a transmission arrangement (not shown in more detail) of the portable power tool 43a, said transmission arrangement being in the form of an angular transmission. The drive motor 14a drives the application tool fastening 16a via the transmission arrangement.

The drive motor 14a is arranged within a main handle 44a of the portable power tool 43a on a side 20a of the portable power tool 43a that is remote from the application tool fastening 16a. The bearing unit 18a is arranged downstream of the drive motor 14a as seen from the application tool fastening 16a. The bearing unit 18a supports the driveshaft 12a on the side 20a remote from the application tool fastening 16a and has a sealing element (not illustrated in more detail). A further bearing unit (not illustrated in more detail) supports the driveshaft 12a on a side 46a facing the application tool fastening 16a.

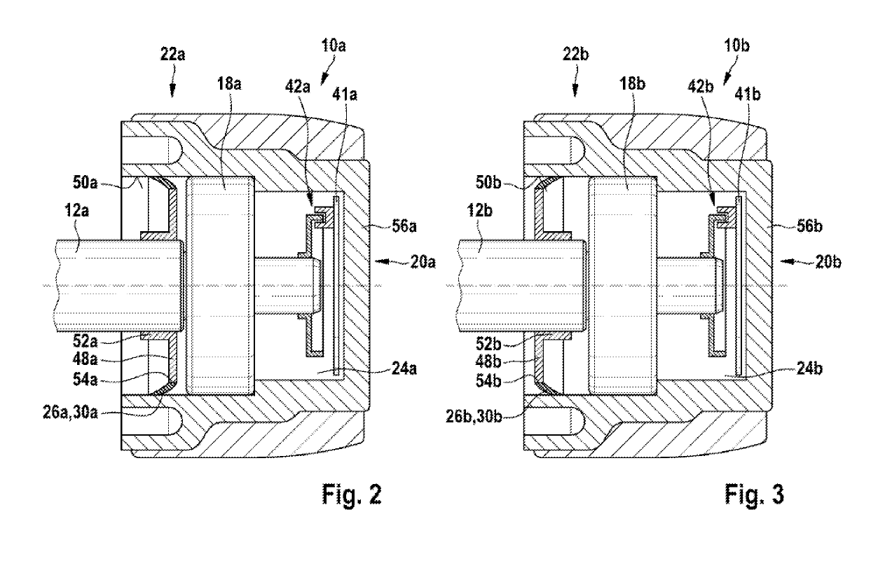

As FIG. 2 shows, the portable power tool device 10a has a sealing device 22a. The sealing device 22a seals off a region 24a located axially next to the bearing unit 18a. The region 24a is arranged on a side 20a of the bearing unit 18a that is remote from the application tool fastening 16a and has a substantially cylindrical shape. The portable power tool device has an electronic unit 41a and a sensor 42a, which are arranged in the sealed-off region 24a. The sensor 42a senses a rotational speed of the driveshaft 12a. The electronic unit 41a has a computing unit (not illustrated in more detail) in the form of a microcontroller and controls or regulates the drive motor 14a during operation. The sealing device 22a is arranged between the drive motor 14a and the bearing unit 18a.

The sealing device 22a has a sealing element 26a, which is separated from the bearing unit 18a and is in the form of a sealing lip 30a, and said sealing device 22a also has a sealing disk 48a and a sealing surface 50a. The sealing disk 48a is connected to the driveshaft 12a in a rotationally fixed and sealed manner. To this end, the sealing disk 48a has a tubular fastening region 52a. Alternatively, a sealing disk could be formed at least partially in one piece with a driveshaft. The sealing disk 48a is connected to the sealing element 26a in an annular connection region 54a and spaces the sealing element 26a apart from the driveshaft 12a in the radial direction. As seen from the annular connection region 54a, the sealing element 26a has a main extent in a direction which is directed in the direction of the application tool fastening 16a and radially outward. The direction of the main extent has an angle of approximately 15 degrees to an axial direction. During operation, the sealing element 26a slides in a sealing manner along the sealing surface 50a at an end remote from the annular connection region 54a. The sealing surface 50a is formed in one piece with a housing 56a of the portable power tool 43a and is oriented substantially axially. Alternatively, a sealing surface composed of a material that appears to be practical to a person skilled in the art could be connected to the housing. A housing of the portable power tool 43a could be formed in multiple parts.

FIGS. 3 to 22 show 20 further exemplary embodiments of the invention. In order to differentiate the exemplary embodiments, the letter a in the reference signs of the exemplary embodiment in FIGS. 1 and 2 is replaced by the letters b to u in the reference signs of the exemplary embodiments in FIGS. 3 to 22. The following descriptions are restricted substantially to the differences between the exemplary embodiments, it being possible to refer to the description of the other exemplary embodiments, in particular to the description of the exemplary embodiments in FIGS. 1 and 2, with regard to components, features and functions that remain the same. In particular, it is conceivable to arrange the shown sealing devices in front of and behind the bearing unit, simply or in a staggered manner and in different combinations that appear to be practical to a person skilled in the art, and said sealing devices can be mirrored at least about a plane that is formed perpendicularly to an axial direction of the driveshaft. Furthermore, in all sealing devices, the sealing disks and/or the sealing elements can be connected in a rotationally fixed manner to the housing of the portable power tool or to the driveshaft.

Like FIG. 2, FIG. 3 shows a portable power tool device 10b having a driveshaft 12b and a bearing unit 18b which supports the driveshaft 12b on a side 20b which is remote from an application tool fastening 16b. The portable power tool device 10b has a sealing device 22b which seals off a region 24b that is located axially next to the bearing unit 18b and is arranged on a side 20b of the bearing unit 18b that is remote from the application tool fastening 16b.

The sealing device 22b has a sealing element 26b which is formed separately from the bearing unit 18b and as a sealing lip 30b, and also has a sealing disk 48b and a sealing surface 50b. As seen from an annular connection region 54b, the sealing element 26b has a main extent in a direction which is directed in the direction away from the application tool fastening 16b and radially outward.

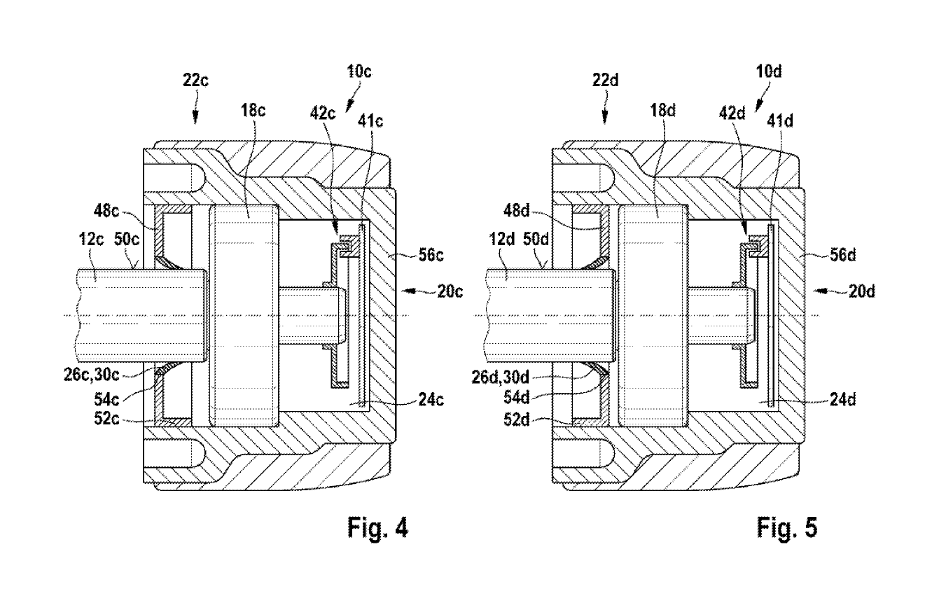

Like FIG. 2, FIG. 4 shows a portable power tool device 10c having a driveshaft 12c and a bearing unit 18c which supports the driveshaft 12c on a side 20c which is remote from an application tool fastening 16c. The portable power tool device 10c has a sealing device 22c which seals off a region 24c that is located axially next to the bearing unit 18c and is arranged on a side 20c of the bearing unit 18c that is remote from the application tool fastening 16c.

The sealing device 22c has a sealing element 26c which is formed separately from the bearing unit 18c and as a sealing lip 30c, and also has a sealing disk 48c and a sealing surface 50c. The sealing disk 48c is connected in a rotationally fixed manner to a housing 56c of a portable power tool 43c. During operation, the sealing lip 30c slides along the sealing surface 50c, which is formed in one piece with the driveshaft 12c. As seen from an annular connection region 54c, the sealing element 26c has a main extent in a direction which is directed in the direction away from the application tool fastening 16c and radially inward.

Like FIG. 3, FIG. 5 shows a portable power tool device 10d having a driveshaft 12d and a bearing unit 18d which supports the driveshaft 12d on a side 20d which is remote from an application tool fastening 16d. The portable power tool device 10d has a sealing device 22d which seals off a region 24d that is located axially next to the bearing unit 18d and is arranged on a side 20d of the bearing unit 18d that is remote from the application tool fastening 16d.

The sealing device 22d has a sealing element 26d which is formed separately from the bearing unit 18d and as a sealing lip 30d, and also has a sealing disk 48d and a sealing surface 50d. As seen from an annular connection region 54d, the sealing element 26d has a main extent in a direction which is directed in the direction of the application tool fastening 16d and radially inward.

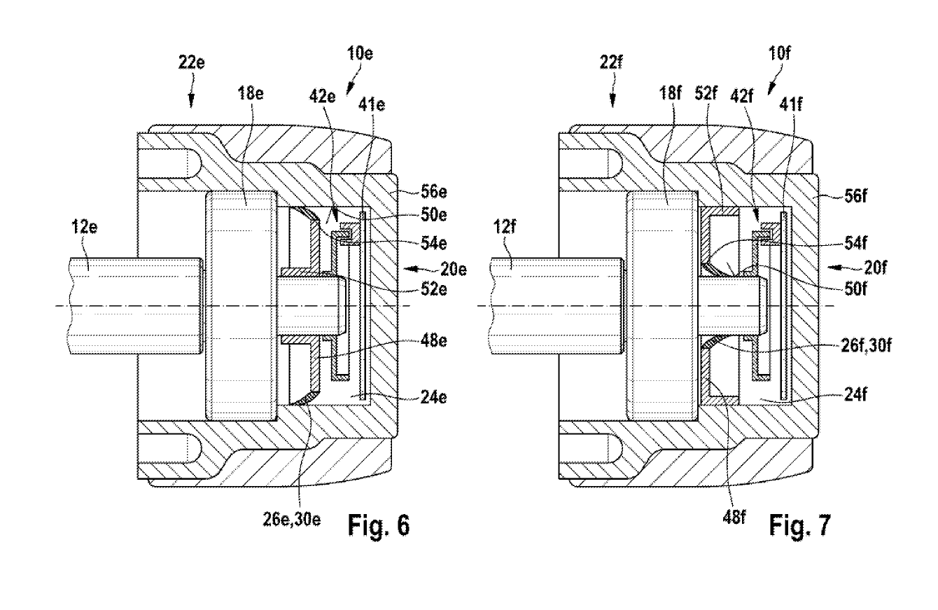

Like FIG. 2, FIG. 6 shows a portable power tool device 10e having a driveshaft 12e and a bearing unit 18e which supports the driveshaft 12e on a side 20e which is remote from an application tool fastening 16e. The portable power tool device 10e has a sealing device 22e which seals off a region 24e that is located axially next to the bearing unit 18e and is arranged on a side 20e of the bearing unit 18e that is remote from the application tool fastening 16e.

The sealing device 22e has a sealing element 26e which is formed separately from the bearing unit 18e and as a sealing lip 30e, and also has a sealing disk 48e and a sealing surface 50e. The sealing device 22e is arranged on a side 20e of the bearing unit 18e that is remote from the drive motor 14e.

Like FIG. 4, FIG. 7 shows a portable power tool device 10f having a driveshaft 12f and a bearing unit 18f which supports the driveshaft 12f on a side 20f which is remote from an application tool fastening 16f. The portable power tool device 10f has a sealing device 22f which seals off a region 24f that is located axially next to the bearing unit 18f and is arranged on a side 20f of the bearing unit 18f that is remote from the application tool fastening 16f.

The sealing device 22f has a sealing element 26f which is formed separately from the bearing unit 18f and as a sealing lip 30f, and also has a sealing disk 48f and a sealing surface 50f. The sealing device 22f is arranged on a side 20f of the bearing unit 18f that is remote from the drive motor 14f. The sealing disk 48f is connected in a rotationally fixed manner to a housing 56f of a portable power tool 43f.

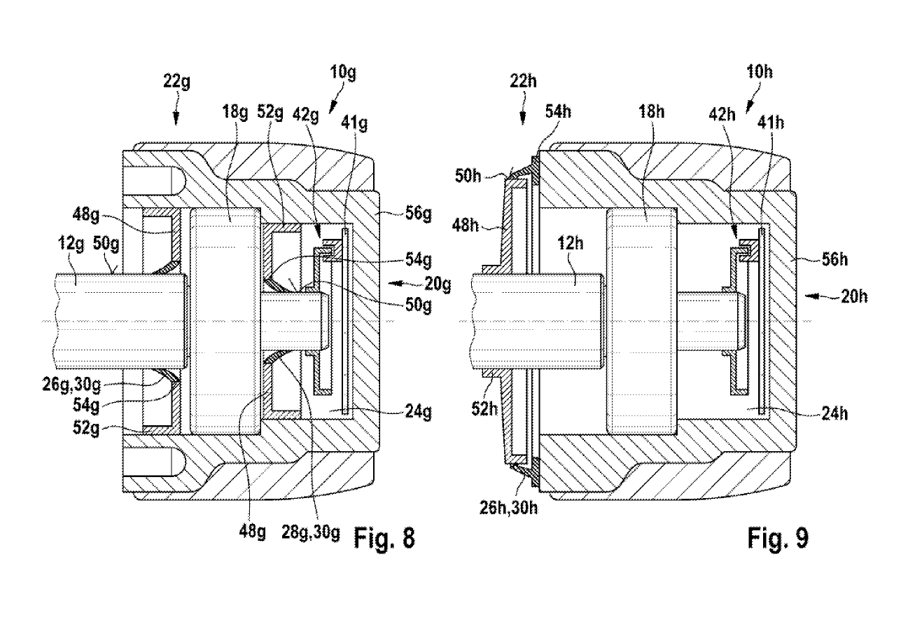

Like FIG. 5, FIG. 8 shows a portable power tool device 10g having a driveshaft 12g and a bearing unit 18g which supports the driveshaft 12g on a side 20g which is remote from an application tool fastening 16g. The portable power tool device 10g has a sealing device 22g which seals off a region 24g that is located axially next to the bearing unit 18g and is arranged on a side 20g of the bearing unit 18g that is remote from the application tool fastening 16g.

The sealing device 22g has two sealing elements 26g, 28g that are formed separately from the bearing unit 18g and as sealing lips 30g, and also has two sealing disks 48g and two sealing surfaces 50g. The two sealing elements 26g, 28g are arranged on different sides of the bearing unit 18g in the axial direction. Both sealing disks 48g are connected in a rotationally fixed manner to a housing 56g of a portable power tool 43g. The sealing lips 30g are directed in different directions.

Like FIG. 2, FIG. 9 shows a portable power tool device 10h having a driveshaft 12h and a bearing unit 18h which supports the driveshaft 12h on a side 20h which is remote from an application tool fastening 16h. The portable power tool device 10h has a sealing device 22h which seals off a region 24h that is located axially next to the bearing unit 18h and is arranged on a side 20h of the bearing unit 18h that is remote from the application tool fastening 16h.

The sealing device 22h has a sealing element 26h which is formed separately from the bearing unit 18h and as a sealing lip 30h, and also has a sealing disk 48h and a sealing surface 50h. The sealing element 26h is connected in a rotationally fixed manner to a housing 56h of a portable power tool 43h. The sealing disk 48h is connected in a rotationally fixed manner to the driveshaft 12h. The sealing surface 50h is formed in one piece with the sealing disk 48h and is arranged coaxially with the driveshaft 12h. The sealing element 26h is prestressed in an operationally ready operating state and presses against the sealing surface 50h radially from the outside. Furthermore, as seen from a connection region 54h to the housing 56h, the sealing element 26h has a main extent in a direction which is directed in the direction of the application tool fastening 16h and radially inward. The sealing lip 30h could be produced with the housing in a two-component injection-molding process.

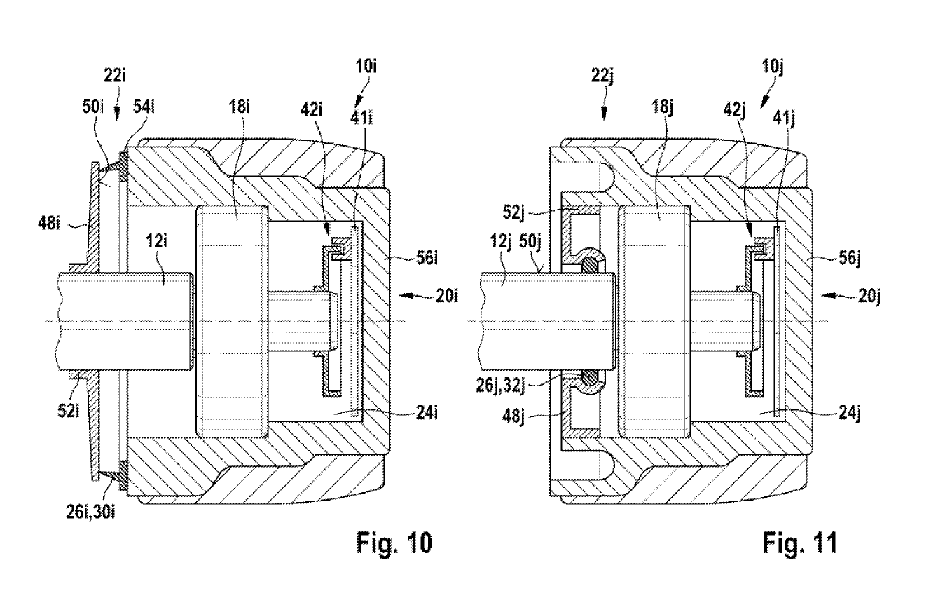

Like FIG. 9, FIG. 10 shows a portable power tool device 10i having a driveshaft 12i and a bearing unit 18i which supports the driveshaft 12i on a side 20i which is remote from an application tool fastening 16i. The portable power tool device 10i has a sealing device 22i which seals off a region 24i that is located axially next to the bearing unit 18i and is arranged on a side 20i of the bearing unit 18i that is remote from the application tool fastening 16i.

The sealing device 22i has a sealing element 26i which is formed separately from the bearing unit 18i and as a sealing lip 30i, and also has a sealing disk 48i and a sealing surface 50i. The sealing surface 50i is formed in one piece with the sealing disk 48i and is arranged perpendicularly to an axial direction. The sealing element 26i is prestressed in an operationally ready operating state and presses against the sealing surface 50i axially in the direction of the application tool fastening 16i. The sealing device 22i could have a plurality of sealing lips formed in a similar manner.

Like FIG. 2, FIG. 11 shows a portable power tool device 10j having a driveshaft 12j and a bearing unit 18j which supports the driveshaft 12j on a side 20j which is remote from an application tool fastening 16j. The portable power tool device 10j has a sealing device 22j which seals off a region 24j that is located axially next to the bearing unit 18j and is arranged on a side 20j of the bearing unit 18j that is remote from the application tool fastening 16j.

The sealing device 22j has a sealing element 26j which is formed separately from the bearing unit 18j and as a sealing ring 32j, and also has a sealing surface 50j and a sealing disk 48j, which is formed as a sealing ring socket. The sealing disk 48j is connected in a rotationally fixed manner to a housing 56j of a portable power tool 43j. The sealing surface 50j is formed in one piece with the driveshaft 12j and is arranged parallel to an axial direction. The sealing element 26j slides between the sealing surface 50j and a groove in the sealing disk 48j. The sealing element 26j presses against the sealing surface 50j axially toward the inside and is formed as an O-ring.

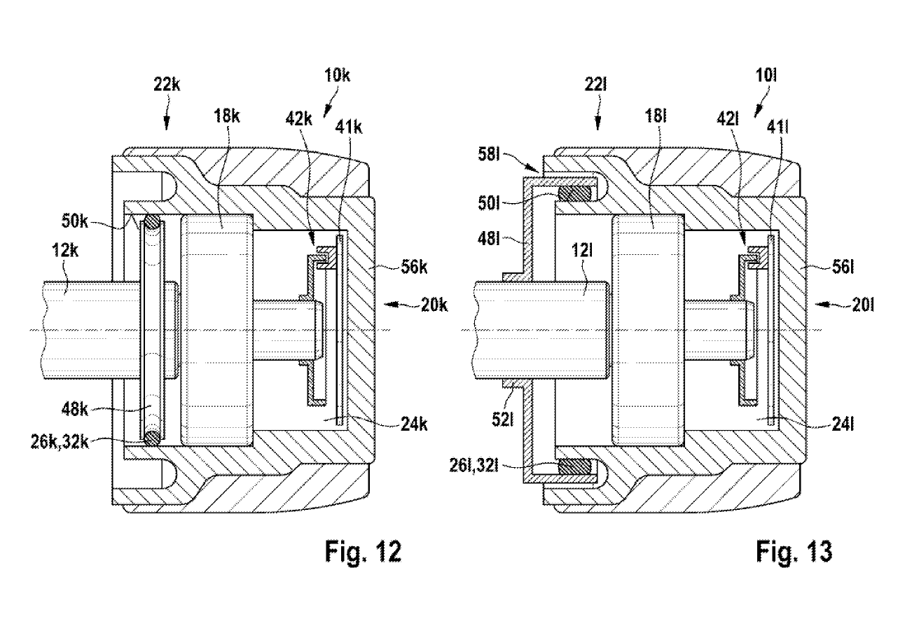

Like FIG. 11, FIG. 12 shows a portable power tool device 10k having a driveshaft 12k and a bearing unit 18k which supports the driveshaft 12k on a side 20k which is remote from an application tool fastening 16k. The portable power tool device 10k has a sealing device 22k which seals off a region 24k that is located axially next to the bearing unit 18k and is arranged on a side 20k of the bearing unit 18k that is remote from the application tool fastening 16k.

The sealing device 22k has a sealing element 26k which is formed separately from the bearing unit 18k, and also has a sealing surface 50k and a sealing disk 48k. The sealing disk 48k is formed partially in one piece with the driveshaft 12k. The sealing surface 50k is formed in one piece with a housing 56k of a portable power tool 43k and is arranged parallel to an axial direction. The sealing element 26k presses against the sealing surface 50k axially toward the outside. Alternatively or in addition, a sealing element could press against a sealing surface axially toward the inside. The sealing element 26k is formed as a permanently greased sealing ring 32k, but could alternatively also be formed from polytetrafluoroethylene, foam or some other material that appears to be practical to a person skilled in the art.

Like FIG. 12, FIG. 13 shows a portable power tool device 101 having a driveshaft 121 and a bearing unit 181 which supports the driveshaft 121 on a side 201 which is remote from an application tool fastening 161. The portable power tool device 101 has a sealing device 221 which seals off a region 241 that is located axially next to the bearing unit 181 and is arranged on a side 201 of the bearing unit 181 that is remote from the application tool fastening 161.

The sealing device 221 has a sealing element 261 which is formed separately from the bearing unit 181 and as a sealing ring 321, and also has a sealing surface 501 and a sealing disk 481. The sealing disk 481 is connected in a rotationally fixed manner to the driveshaft 121 and projects, partially in a tubular form, into a recess 581 in a housing 561 of a portable power tool 431. In the recess, the sealing element 261 is arranged radially inside the sealing disk 481. The sealing surface 501 is formed in one piece with the housing 561 and is arranged parallel to an axial direction. The sealing element 261 presses against the sealing surface 501 axially toward the inside. Alternatively, a sealing element could press against a sealing surface axially toward the outside.

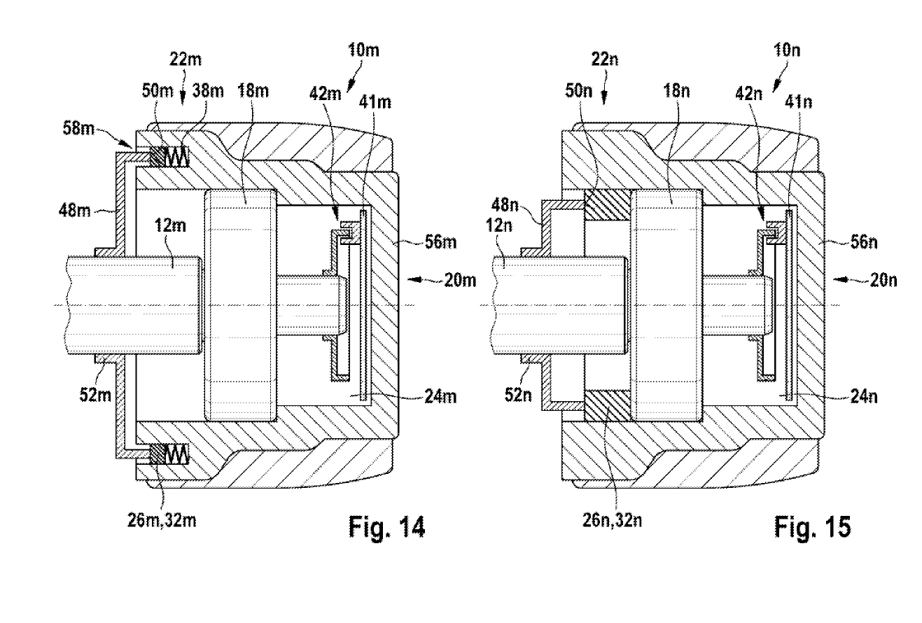

Like FIG. 13, FIG. 14 shows a portable power tool device 10m having a driveshaft 12m and a bearing unit 18m which supports the driveshaft 12m on a side 20m which is remote from an application tool fastening 16m. The portable power tool device 10m has a sealing device 22m which seals off a region 24m that is located axially next to the bearing unit 18m and is arranged on a side 20m of the bearing unit 18m that is remote from the application tool fastening 16m.

The sealing device 22m has a sealing element 26m which is formed separately from the bearing unit 18m and as a sealing ring 32m, and also has a spring element 38m and a sealing disk 48m. The sealing disk 48m projects, partially in a tubular form, into a recess 58m in a housing 56m of a portable power tool 43m. In an operationally ready state, the spring element 38m exerts a force on the sealing element 26m and presses the sealing element 26m in a sliding manner against a sealing surface 50m of the sealing disk 48m in a direction facing the application tool fastening 16m. The sealing element 26m exerts a sealing force on two axially oriented surfaces of the recess 58m.

Like FIG. 12, FIG. 15 shows a portable power tool device 10n having a driveshaft 12n and a bearing unit 18n which supports the driveshaft 12n on a side 20n which is remote from an application tool fastening 16n. The portable power tool device 10n has a sealing device 22n which seals off a region 24n that is located axially next to the bearing unit 18n and is arranged on a side 20n of the bearing unit 18n that is remote from the application tool fastening 16n.

The sealing device 22n has a sealing element 26n which is formed separately from the bearing unit 18n and as a sealing ring 32n, and also has a sealing surface 50n and a sealing disk 48n. The sealing element 26n is loaded in a sliding manner by the sealing disk 48n from one side in the axial direction and is held by the bearing unit 18n from another side in the axial direction. Furthermore, the sealing element 26n is prestressed in the radial direction with respect to a housing 56n of a portable power tool 43n. The sealing surface 50n is oriented perpendicularly to the axial direction and is formed in one piece with the sealing disk 48n. The sealing disk 48n is formed in a partially elastic manner in a region that extends radially.

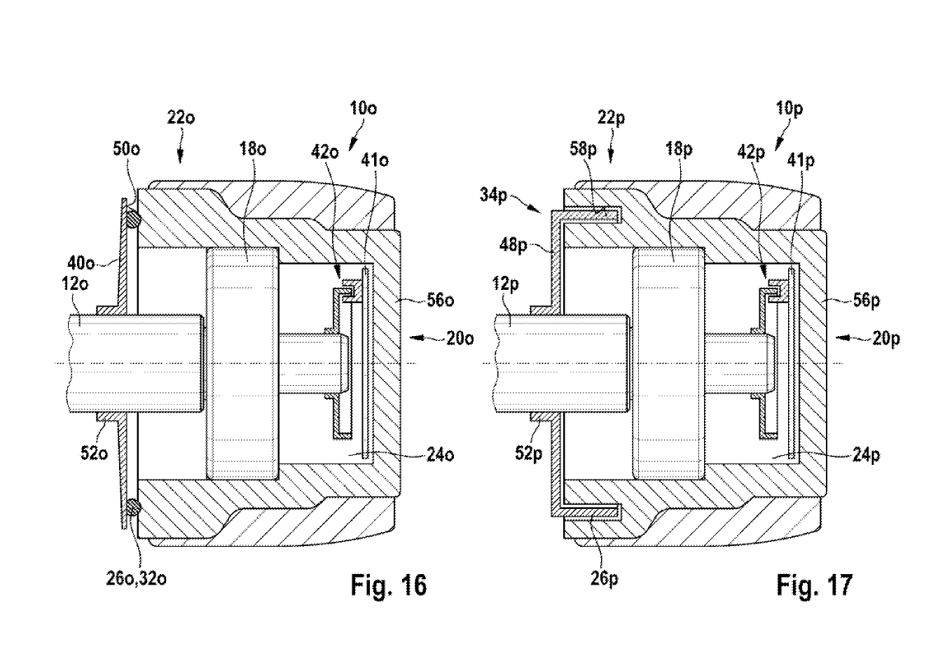

Like FIG. 15, FIG. 16 shows a portable power tool device 10o having a driveshaft 12o and a bearing unit 18o which supports the driveshaft 120 on a side 200 which is remote from an application tool fastening 16o. The portable power tool device 10o has a sealing device 22o which seals off a region 24o that is located axially next to the bearing unit 18o and is arranged on a side 200 of the bearing unit 18o that is remote from the application tool fastening 160.

The sealing device 22o has a sealing element 26o which is formed separately from the bearing unit 18o and as a sealing ring 32o, and also has a sealing surface 50o and an elastic sealing disk 40o. The sealing element 26o is loaded in a sliding manner by the sealing disk 40o from one side in the axial direction and is held by a housing 56o of a portable power tool 43o from another side in the axial direction. The sealing disk 40o could have aerodynamic elements (not illustrated in more detail), such as helical flutes, an undulating profile or vane elements, for example.

Like FIG. 2, FIG. 17 shows a portable power tool device 10p having a driveshaft 12p and a bearing unit 18p which supports the driveshaft 12p on a side 20p which is remote from an application tool fastening 16p. The portable power tool device 10p has a sealing device 22p which seals off a region 24p that is located axially next to the bearing unit 18p and is arranged on a side 20p of the bearing unit 18p that is remote from the application tool fastening 16p.

The sealing device 22p comprises a labyrinth seal 34p. The labyrinth seal 34p has a tubular sealing element 26p which is formed separately from the bearing unit 18p and is formed as a labyrinth sealing element. The sealing element 26p projects in the axial direction into a recess 58p in a housing 56p of a portable power tool 43p and extends in a noncontact manner. A sealing element of the sealing device 22p could also be formed partially in one piece with the driveshaft 12p and/or the housing 56p and/or be formed in a hollow conical manner.

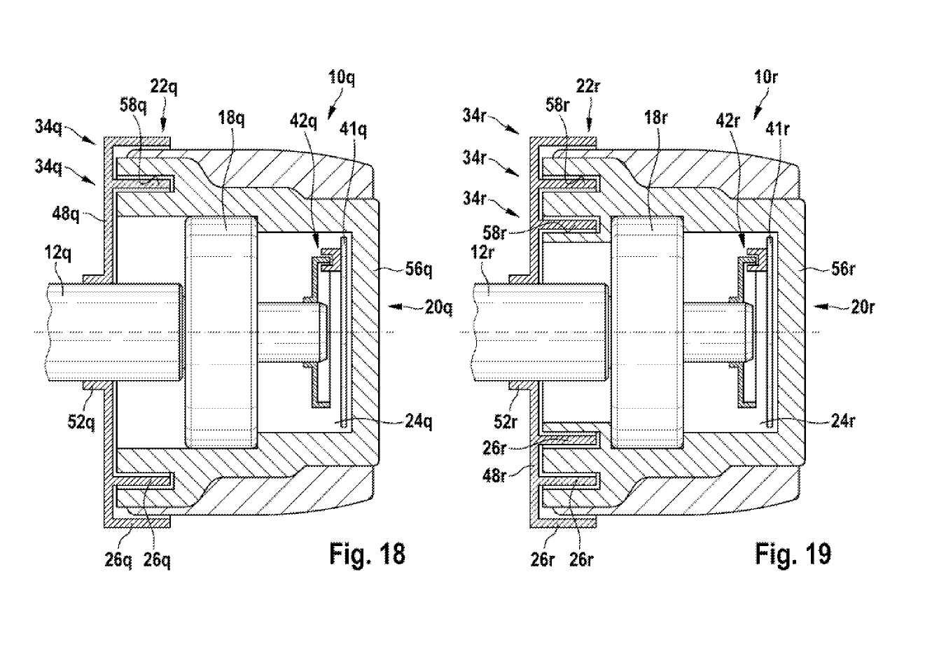

Like FIG. 17, FIG. 18 shows a portable power tool device 10q having a labyrinth seal 34q, which has two hollow cylindrical sealing elements 26q that extend parallel to one another and are formed as labyrinth sealing elements. The sealing elements 26q are arranged radially in succession, but could alternatively be arranged axially alongside one another. At least one of the sealing elements 26q could be formed in an elastic manner and act as part of a centrifugal seal.

Like FIG. 17, FIG. 19 shows a portable power tool device 10r having a labyrinth seal 34r, which has three tubular sealing elements 26r that extend parallel to one another and are formed as labyrinth sealing elements.

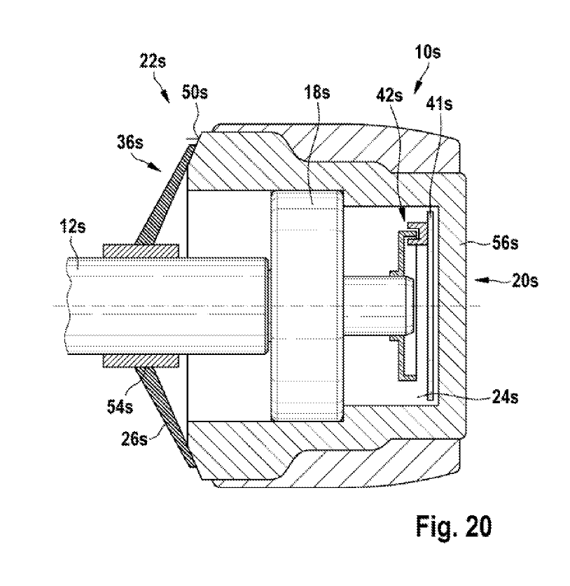

Like FIG. 2, FIG. 20 shows a portable power tool device 10s having a driveshaft 12s and a bearing unit 18s which supports the driveshaft 12s on a side 20s which is remote from an application tool fastening 16s. The portable power tool device 10s has a sealing device 22s which seals off a region 24s that is located axially next to the bearing unit 18s and is arranged on a side 20s of the bearing unit 18s that is remote from the application tool fastening 16s.

The sealing device 22s comprises a centrifugal seal 36s which has a sealing element 26s which is formed separately from the bearing unit 18s and has a sealing surface 50s. The sealing element 26s is connected in a rotationally fixed manner to the driveshaft 12s and is formed as an elastic sealing sleeve. The sealing element 26s has a main direction of extent, which points, from a connection region 54s to the driveshaft 12s, in a direction that is directed away from the application tool fastening 16s and radially outward, that is to say that the sealing element 26s is formed in a substantially hollow conical manner. The sealing surface 50s is oriented substantially parallel to the sealing element 26s in a resting operating state and is formed in one piece with a housing 56s of a portable power tool 43s. When the driveshaft 12s rotates, centrifugal forces bend the sealing element 26s away from the sealing surface 50s, and so the sealing element 26s and the sealing surface 50s are then spaced apart from one another at every point. A sealing effect is retained during operation by centrifugal forces acting on chips.

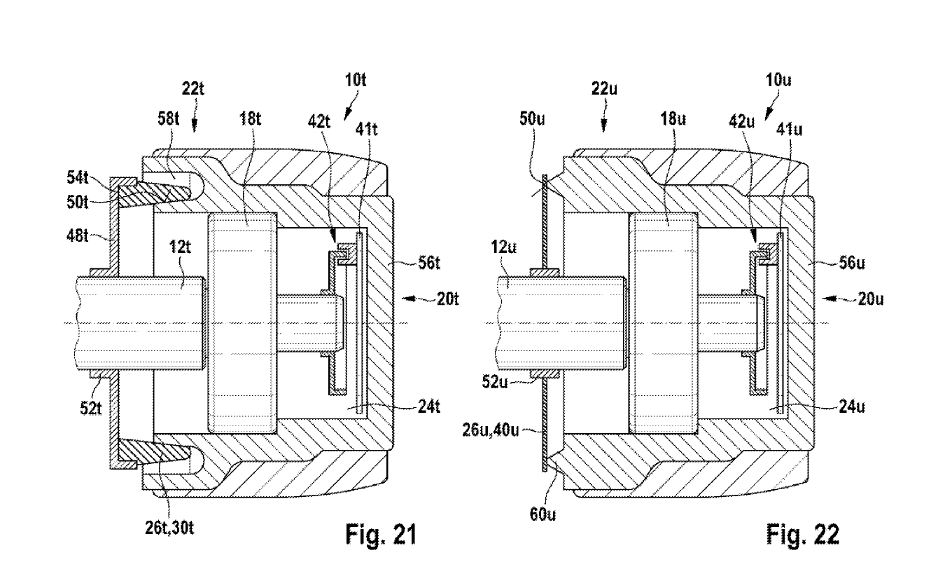

Like FIG. 20, FIG. 21 shows a portable power tool device 10t having a driveshaft 12t and a bearing unit 18t which supports the driveshaft 12t on a side 20t which is remote from an application tool fastening 16t. The portable power tool device 10t has a sealing device 22t which seals off a region 24t that is located axially next to the bearing unit 18t and is arranged on a side 20t of the bearing unit 18t that is remote from the application tool fastening 16t.

The sealing device 22t is formed as a centrifugal seal 36t and has a sealing element 26t and a sealing surface 50t. The sealing element 26t is formed separately from the bearing unit 18t and as a sealing lip 30t and is oriented substantially parallel to an axial direction of the driveshaft 12t. The sealing surface 50t is likewise oriented substantially parallel to an axial direction and formed in a hollow cylindrical manner.

Like FIG. 2, FIG. 22 shows a portable power tool device 10u having a driveshaft 12u and a bearing unit 18u which supports the driveshaft 12u on a side 20u which is remote from an application tool fastening 16u. The portable power tool device 10u has a sealing device 22u which seals off a region 24u that is located axially next to the bearing unit 18u and is arranged on a side 20u of the bearing unit 18u that is remote from the application tool fastening 16u.

The sealing device 22u has a sealing element 26u which is formed separately from the bearing unit 18u and as an elastic sealing disk 40u, and also has a sealing edge 60u or alternatively a plurality of sealing edges. The sealing disk 40u is arranged substantially perpendicularly to an axial direction of the driveshaft 12u and is connected in a rotationally fixed manner to the driveshaft 12u. The sealing disk 40u slides in a sealing manner over the sealing edge 60u and is stabilized in the process by centrifugal forces. The sealing edge 60u is integrally formed on a housing 56u of a portable power tool 43u. A sealing edge could alternatively or in addition be integrally formed on the sealing disk 40u. If the sealing device has a plurality of sealing edges, these are formed with different heights. Further sealing elements that appear to be practical to a person skilled in the art are additionally possible.

1. A portable power tool device, comprising:
at least one driveshaft,
a drive motor,
an application tool fastening,
at least one bearing unit configured to support the at least one driveshaft on a side of the drive motor that is remote from the application tool fastening, and
a sealing device configured to seal off at least a region which is located axially next to the at least one bearing unit, said sealing device being arranged on a side of the at least one bearing unit that is remote from the application tool fastening,
wherein the sealing device has at least one sealing element which is formed separately from the at least one bearing unit.

2. The portable power tool device as claimed in claim 1, wherein the sealing device has at least two sealing elements.

3. The portable power tool device as claimed in claim 2, wherein the two sealing elements are arranged on different sides of the at least one bearing unit.

4. The portable power tool device as claimed in claim 1, wherein the at least one bearing unit has at least one sealing element.

5. The portable power tool device as claimed in claim 1, wherein the sealing device has a sealing lip.

6. The portable power tool device as claimed in claim 5, wherein the sealing lip is prestressed in at least one operating state.

7. The portable power tool device as claimed in claim 1, wherein the sealing device has a sealing ring.

8. The portable power tool device as claimed in claim 1, wherein the sealing device has at least one labyrinth seal.

9. The portable power tool device as claimed in claim 1, wherein the sealing device comprises at least one centrifugal seal.

10. The portable power tool device as claimed in claim 1, wherein the sealing device has at least one spring element configured to exert a force on a sealing mechanism.

11. The portable power tool device as claimed in claim 1, wherein the sealing device has an elastic sealing disk.

12. The portable power tool device as claimed in claim 1, further comprising at least one electronic unit and at least one sensor which are arranged in the sealed-off region.

13. A portable power tool having a portable power tool device, comprising:
at least one driveshaft,
a drive motor,
an application tool fastening,
at least one bearing unit configured to support the at least one driveshaft on a side of the drive motor that is remote from the application tool fastening, and
a sealing device configured to seal off at least a region which is located axially next to the at least one bearing unit, said sealing device being arranged on a side of the at least one bearing unit that is remote from the application tool fastening,
wherein the sealing device has at least one sealing element which is formed separately from the at least one bearing unit.
